(19) United States
(12) Patent Application Publication
(10) Pub. No.: US 2008/0054579 A1
(43) Pub. Date: Mar. 6, 2008

(54) Golf travel bag

(76) Inventor: Jui-Ching Liu, Taipei (TW)

Correspondence Address: CHARLES E. BAXLEY, ESQ., 90 JOHN STREET, THIRD FLOOR, NEW YORK, NY, 10038, US

(21) Appl. No.: 11/514,503

(22) Filed: Sep. 1, 2006

(51) Int. Cl. B62B 3/02

(52) U.S. Cl. 280/35

(57) ABSTRACT

A golf travel bag has a bag and a foldable mini-cart. The bag holds a fully populated golf bag and has a side and a bottom. The foldable mini-cart is attached to the bag and has a longitudinal frame and a foldable wheel assembly. The longitudinal frame is attached to the side and the bottom of the bag. The foldable wheel assembly is attached to the longitudinal frame at a selectable angle and has a frame, at least one latch assembly and at least two wheels. The latch assembly holds the foldable wheel assembly at an angle relative to the longitudinal frame. The wheels allow the golf travel bag to be moved easily.

### BACKGROUND OF THE INVENTION

1. Field of the Invention

The present invention relates to a golf travel bag, and particularly to a golf travel bag that includes a pull cart.

2. Description of the Prior Art

A conventional golf travel bag is a heavy-duty bag to carry and protect a fully populated golf bag so golf clubs in the golf bag will not fall out of the bag and comprises a bag and at least one optional strap.

The bag holds the golf bag and has at least one opening and a sealing element. The sealing element may be. a zipper and closes or opens the opening.

The strap may be a hand strap, a shoulder strap or both.

The conventional golf travel bag must be carried unless a cart is available.

To overcome the shortcomings, the present invention provides a golf travel bag to mitigate or obviate the aforementioned problems.

### SUMMARY OF THE INVENTION

The main objective of the invention is to provide a golf travel bag that includes a bag and a foldable mini-cart.

The golf travel bag in accordance with the present invention has a bag and a foldable mini-cart.

The bag holds a standard, fully populated golf bag and has a side and a bottom.

The foldable mini-cart attaches to the bag and has a bag support and a foldable wheel assembly.

The bag support is attached to the side and the bottom of the bag.

The foldable wheel assembly is attached to the bag support to hold the bag at a selectable angle and has a frame, at least one latch assembly and at least two wheels. The latch assembly attaches the wheel assembly at a selectable angle to the bag support.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a foldable mini-cart for a golf travel bag in accordance with the present invention;

FIG. 2 is an exploded perspective view of the foldable mini-cart in FIG. 1;

FIG. 3 is a side view of a golf travel bag in accordance with the present invention;

FIG. 4 is an operational side view of the golf travel bag in FIG. 3 with a foldable wheel assembly of the mini-cart in FIG. 1 extended;

FIG. 5 is an operational side view of the foldable mini-cart in FIG. 1 with the foldable wheel assembly folded;

FIG. 6 is an operational side view of the golf travel bag in FIG. 3 with the foldable wheel assembly in FIG. 1 folded; and

FIG. 7 is a perspective view of the foldable mini-cart in FIG. 1 with an additional wheel and two guide slots.

### DETAILED DESCRIPTION OF THE PREFERRED EMBODIMENTS

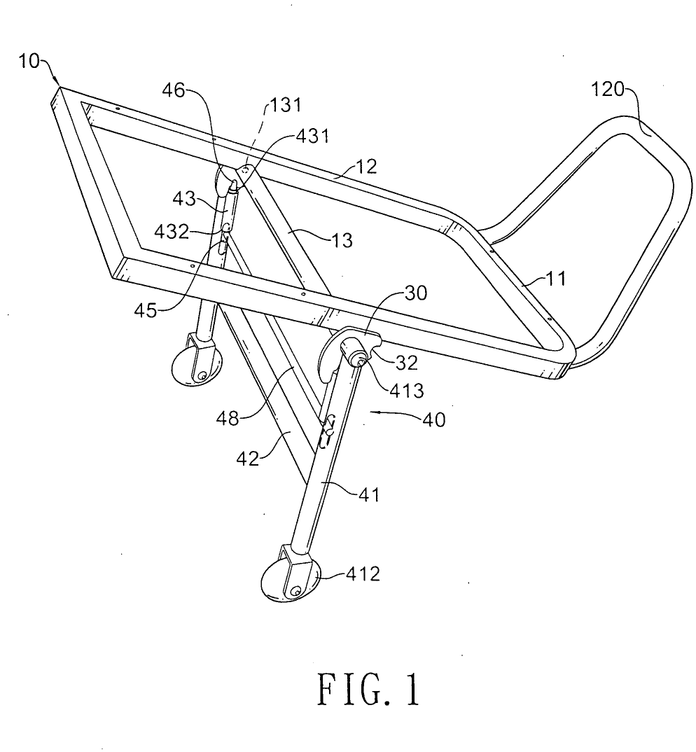

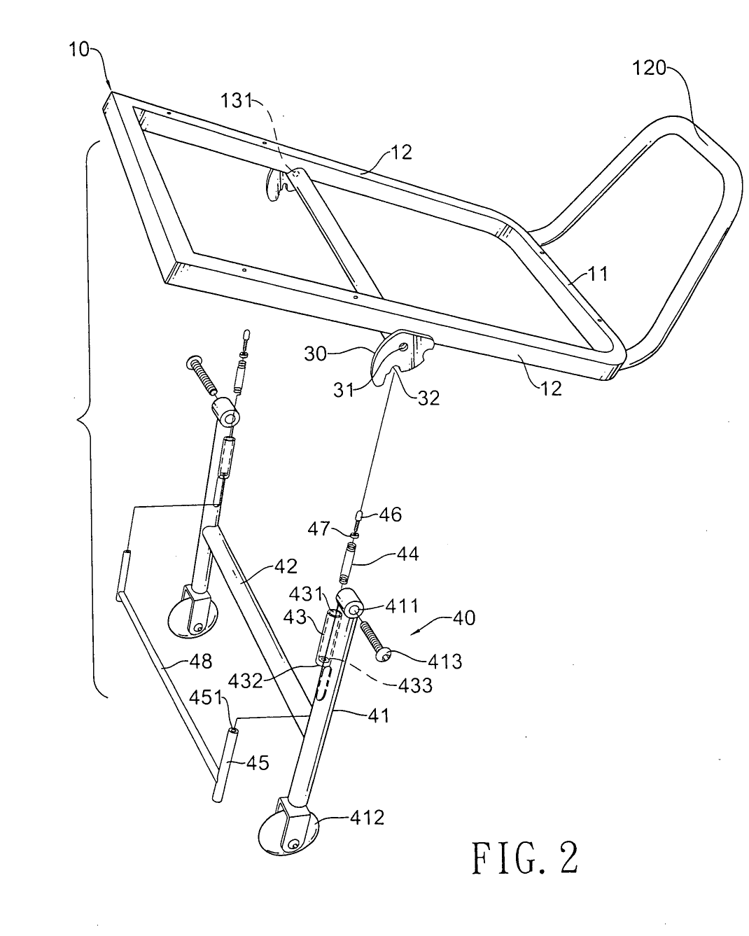

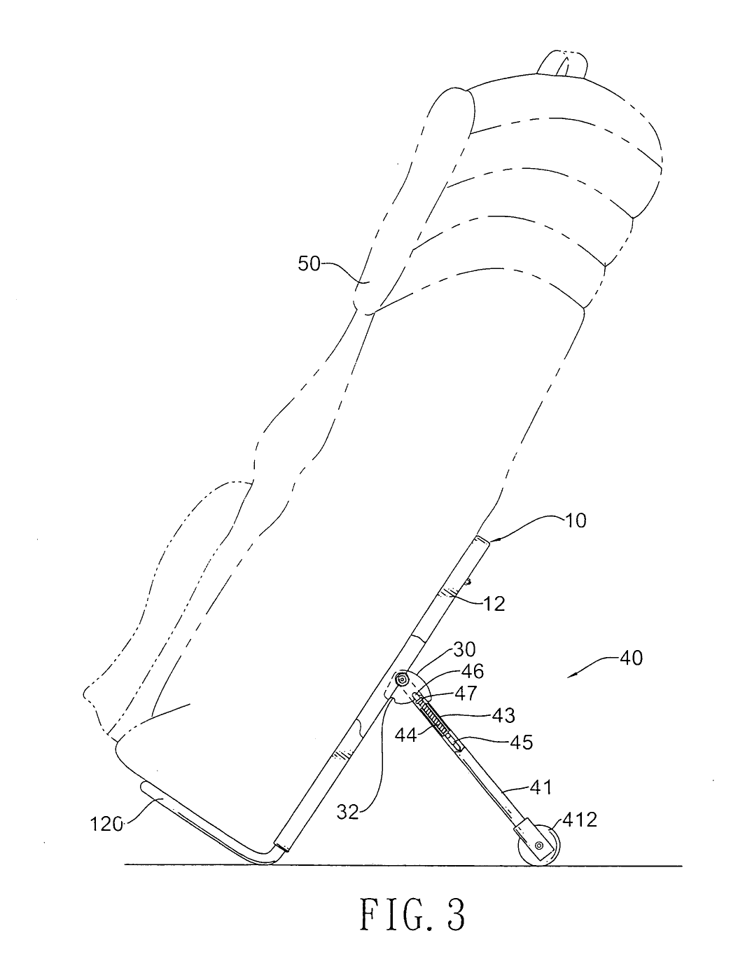

With reference to FIGS. 1, 2 and 3, a golf travel bag in accordance with the present invention comprises a bag (50) and a foldable mini-cart.

The bag (50) holds a fully populated golf bag and has a side and a bottom.

The foldable mini-cart is attached to the bag (50) and has a bag support and a foldable wheel assembly (40).

The bag support is attached to the side and the bottom of the bag (50) and has a longitudinal frame (10) and a foot (120).

The longitudinal frame (10) is rectangular, is attached to the side of the bag at the bottom and has two longitudinal bars (12), a top bar, a bottom bar (11) and a mounting bar (13).

Each longitudinal bar (12) has an outer edge, a top end and a bottom end.

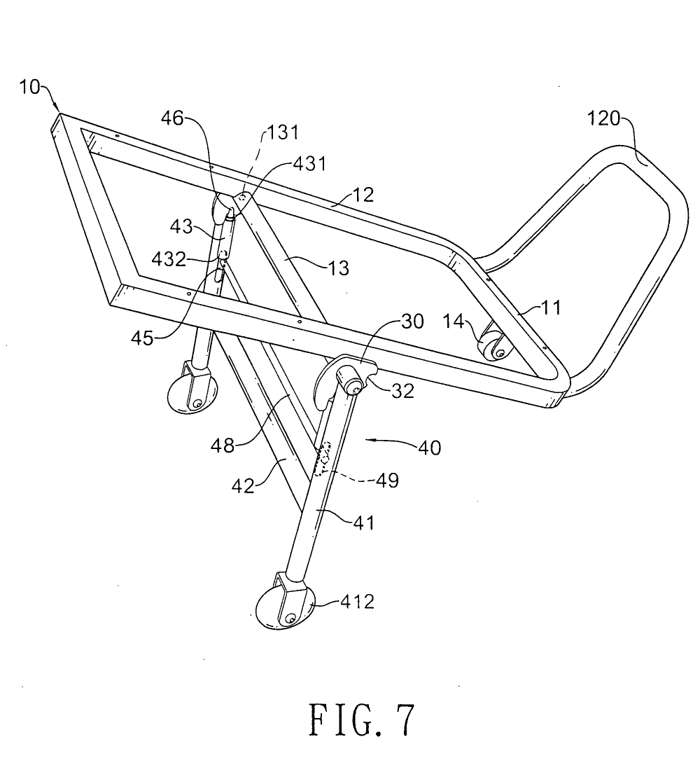

The top bar is attached to the top ends of the longitudinal bars (12). With further reference to FIG. 7, the bottom bar (11) is attached to the bottom ends of the longitudinal bars (12) and may have a wheel (14). The wheel (14) is mounted rotatably on the bottom bar (11).

The mounting bar (13) is connected to the longitudinal bars (12) between the top ends and bottom ends and has two ends and two pivot pin holes (131). The pivot pin holes (131) are formed respectively in the ends of the mounting bar (13).

The foot (120) is attached to and protrudes perpendicularly from the bottom bar (11) and holds the bottom of the bag (50).

The foldable wheel assembly (40) is attached pivotally to the longitudinal frame (10) at a selectable angle and has a frame, at least one latch assembly, an actuator bar (48) and at least two wheels (412).

The frame is H-shaped and has two latch plates (30), two legs (41) and a crossbar (42).

The latch plates (30) are attached respectively to the outer edges of the longitudinal bars (12) and align with each other, and each latch plate (30) has a curved lower edge, a connecting hole (31) and multiple latch notches (32). The latch notches (32) are formed in the curved lower edge at different angles relative to the longitudinal bar (12).

Each leg (41) has a proximal end, a distal end, a pivot sleeve (411), a pivot pin (413) and a guide slot (49).

The pivot sleeve (411) is mounted transversely on the proximal end and has a through hole. The through holes align respectively with the connecting holes (31) in the latch plates (30).

The pivot pins (413) are mounted rotatably respectively through the through holes in the pivot sleeves (411) and the connecting holes (31) in the latch plates (30) and are mounted securely respectively in the pivot pin holes (131) in the mounting bar (13).

The crossbar (42) connects the two legs (41) between the proximal and distal ends of the legs (41).

The guide slots (49) are formed respectively in the legs (41) between the crossbar (42) and the proximal ends of the legs (41) and align with and face each other.

The latch assemblies selectively engage the latch notches (32) to hold the legs (41) at a specific angle relative to the longitudinal frame (10) and hold the wheel assembly (40) at a selectable angle relative to the longitudinal frame (10), and each latch assembly has an actuating sleeve (43), an actuator (45), an end cap (47), a latch (46), a spring (44) and an actuator bar (48). The actuating sleeves (43) are attached respectively to the legs (41) near the proximal end of the legs (41) and align respectively with the latch plates (30), and each actuating sleeve (42) is tubular and has a proximal end (431), a distal end (432) and an annular lip (433). The annular lip (433) is formed on and protrudes radially in from the distal end (432).

The actuator (45) extends slidably into the actuating sleeve (43) through the distal end (432) and has an inner end (451).

The end cap (47) is mounted on and protrudes radially out from the inner end (451) of the actuator (45) and slidably mounted inside the actuating sleeve (43).

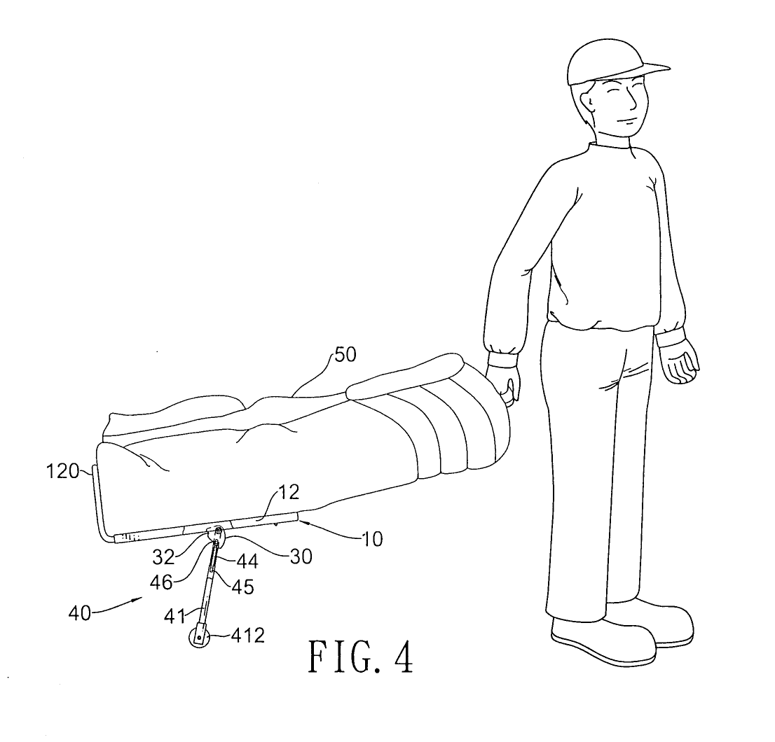

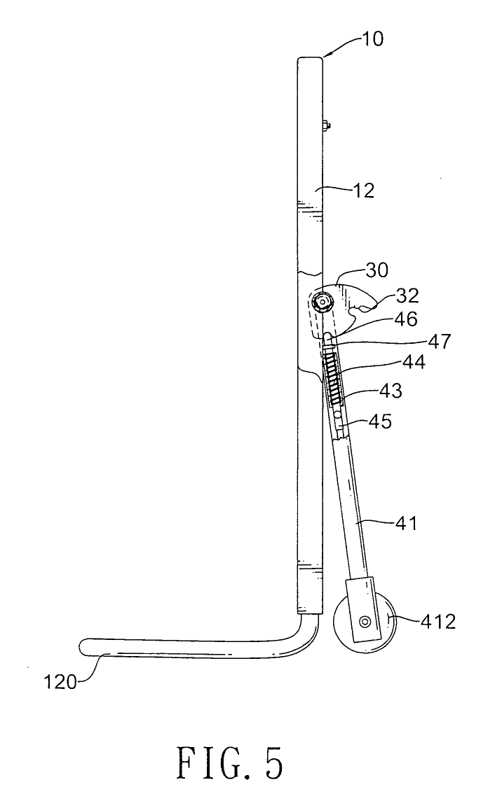

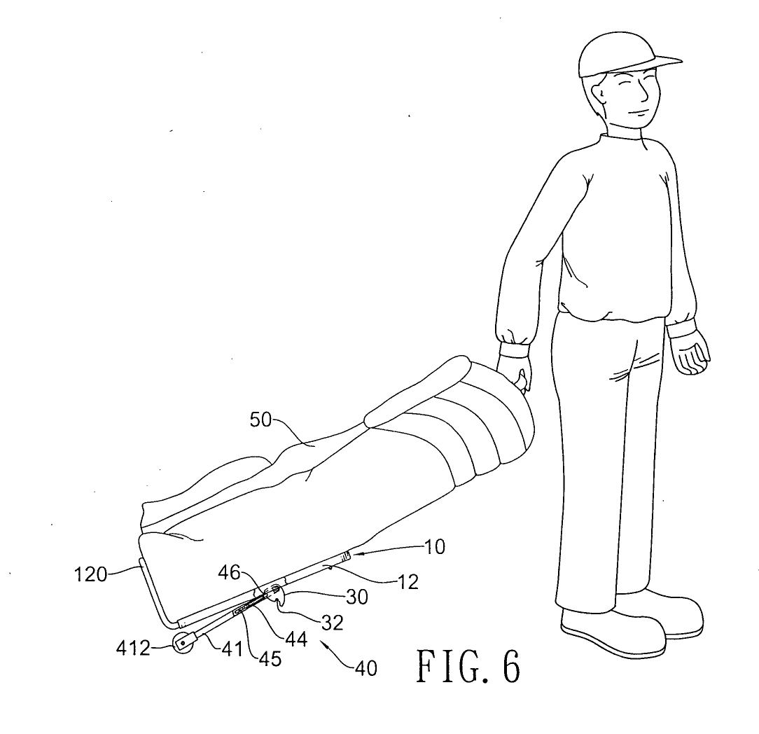

With further reference to FIGS. 4 to 6, the latch (46) is attached to the inner end (451) of the actuator (45) through the end cap (47), protrudes coaxially from the inner end (451) of the actuator (45), extends from the proximal end (431) of the actuating sleeve (43), selectively engages a latch notch (32) to hold the foldable wheel assembly (40) in position and has a shaft and a head.

The shaft is attached coaxially to the inner end (451) of the actuator (45) through the end cap (47) and has a distal end.

The head is formed on the distal end of the shaft and selectively engages a latch notch (32) on the latch plate (30) to hold the foldable wheel assembly (40) in position.

The spring (44) is mounted around the actuator (45) in the actuating sleeve (43) between the annular lip (433) and the end cap (47) and pressing the latch (46) toward the latch plate (30) so the head of the latch (46) will engage a corresponding latch notch (32) on the latch plate (30).

The actuator bar (48) is connected to the actuators (45), allows the actuators (45) to be pulled simultaneously to disengage the latches (46) from the latch plates (30) and may extend through the actuators (45) and protrude slidably into the guide slots (49) in the legs (41) as shown in FIG. 7 to limit how much the actuators (45) will move.

The wheels (412) are mounted respectively on the distal ends of the legs (41) and allow the bag (50) to be easily moved without having to carry the bag (50).

The golf travel bag in accordance with the present invention makes carrying a fully populated golf bag easy and convenient.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A golf travel bag comprising
a bag having a side and a bottom; and
a foldable mini-cart being attached to the bag and having
a bag support being attached to the side and the bottom of the bag and having
a longitudinal frame being rectangular, being attached to the side of the bag at the bottom and having
two longitudinal bars each having
an outer edge;
a top end; and
a bottom end;
a top bar being attached to the top ends of the longitudinal bars;
a bottom bar being attached to the bottom ends of the longitudinal bars; and
a mounting bar being connected to the longitudinal bars between the top ends and the bottom ends of the longitudinal bars and having
two ends; and
two pivot pin holes formed respectively in the ends of the mounting bar; and
a foot being attached to and protruding from the bottom bar to hold the bottom of the bag; and
a foldable wheel assembly being attached pivotally to the longitudinal frame and having
a frame being H-shaped and having
two latch plates being attached respectively to the outer edges of the longitudinal bars and aligning with each other, and each latch plate having
a curved lower edge;
a connecting hole; and
multiple latch notches being formed in the curved lower edge at different angles relative to a corresponding one of the longitudinal bars;
two legs each having
a proximal end;
a distal end;
a pivot sleeve being mounted transversely on the proximal end of the leg and having a through hole aligning with the connecting holes in the latch plates; and
a pivot pin being mounted rotatably through the through hole in the pivot sleeve and the connecting hole in a corresponding one of the latch plates and being mounted securely in the pivot pin hole in a corresponding mounting bar;
a crossbar connected to the two legs between the proximal and distal ends of the legs;
two latch assemblies selectively engaging the latch notches to hold the legs at a specific angle relative to the longitudinal frame and holding the wheel assembly at a selectable angle relative to the longitudinal frame, and each latch assembly having
an actuating sleeve being attached to one of the legs near the proximal end of the leg and aligning with a corresponding one of the latch plates, and each actuating sleeve having
a proximal end;
a distal end; and
an annular lip being formed on and protruding radially in from the distal end of the actuating sleeve;
an actuator extending slidably into the actuating sleeve through the distal end of the actuating sleeve and having an inner end;
an end cap being mounted on and protruding radially out from the inner end of the actuator and slidably mounted inside the actuating sleeve;
a latch being attached to the inner end of the actuator through the end cap, protruding coaxially from the inner end of the actuator, extending from the proximal end of the actuating sleeve, selectively engaging one of the latch notches in the corresponding latch plate to hold the foldable wheel assembly in position and having
a shaft being attached coaxially to the inner end of the actuator through the end cap and having a distal end; and
a head being formed on the distal end of the shaft and selectively engaging one of the latch notches in the corresponding latch plate to hold the foldable wheel assembly in position; and
a spring being mounted around the actuator in the actuating sleeve between the annular lip and the end cap to press the latch toward the latch plate so the head of the latch will engage one of the latch notches in the corresponding latch plate; and
at least two wheels being mounted respectively on the distal ends of the legs.

2. The golf travel bag as claimed in claim 1, wherein the bottom bar of the longitudinal frame further has a wheel mounted rotatably on the bottom bar.

3. The golf travel bag as claimed in claim 1, wherein the foldable wheel assembly further has an actuator bar connected to the actuators.

4. The golf travel bag as claimed in claim 3, wherein
each leg further has a guide slot formed in the leg between the crossbar and the proximal end of the leg, and the guide slots align with and face each other; and
the actuator bar extends through the actuators and protrudes slidably into the guide slots in the legs.
